(19) United States
(12) Patent Application Publication
(10) Pub. No.: US 2014/0010589 A1
(43) Pub. Date: Jan. 9, 2014

(54) MECHANISM FOR FASTENING THE COVER OF A VACUUM SEALING MACHINE

(71) Applicants: EDWARD Z.H. HU, GUANGDONG (CN); XINZHAI ZHENG, GUANGDONG (CN)

(72) Inventors: EDWARD Z.H. HU, GUANGDONG (CN); XINZHAI ZHENG, GUANGDONG (CN)

(21) Appl. No.: 13/731,122

(22) Filed: Dec. 31, 2012

(30) Foreign Application Priority Data
Jul. 6, 2012 (CN) 201220327930.4

(51) Int. Cl. F16B 17/00

(52) U.S. Cl. CPC F16B 17/00
USPC 403/322.4

(57) ABSTRACT

The utility model discloses a mechanism for fastening the cover of a vacuum sealing machine, which comprises an upper-cover top cap, an upper-cover bottom cap, a base, a handle, a rotating shaft and a locking mechanism. Said upper-cover top cap and said upper-cover bottom cap are fixedly connected to form an upper cover; said handle passes through said upper-cover top cap; the lower end of said handle is fixedly connected with the rotating shaft; the two ends of said rotating shaft are respectively fixedly connected with said locking mechanism; and said upper-cover bottom cap is provided with a bracket for supporting said rotating shaft. The utility model reduces the force required by the handle through the handle and the locking mechanism to fulfill the aim of saving labor.

### BACKGROUND OF THE INVENTION

The utility model relates to a vacuuming device, in particular to a mechanism for fastening the cap of a vacuum sealing machine.

The existing vacuum sealing machine needs to vacuumize in a sealed cavity and press the plastic bag to seal the bag. This requires a sealing element and a hot-press installed on the upper-cover top cap and the base. The sealing element works under a large pressure, while the hot-press seals the bag opening also under a large pressure, so the overall pressure needed by the two parts is very large.

The existing mechanism for fastening the cover of the vacuum sealing machine is classified into two types, one fastens the cover and the base by pressing the top two ends at the same type, and the other performs electric fastening. The mechanism fastening the cover of the vacuum sealing machine by means of pressing the two top two ends at the same time has the following defects: it needs a large pressure to fasten the cover and the base by pressing the two ends; the fastening and loosening operation needs both hands and causes inconvenience; when sealing the bag opening in vacuum, objects in the plastic bag wrinkle the bag opening, and the operator cannot flatten the opening with a hand, thus resulting in poor sealing effect and air leakage. The electric fastening mechanism ha the following defects: the cost of this mechanism is high; the opening angle between the cover and the base is very small and inconvenient for placing the sealing objects and cleaning the interior; the reliability is low; and the structure is complicated.

### BRIEF SUMMARY OF THE INVENTION

The utility model overcomes the defects of the prior art and provides a mechanism for fastening the cover of a vacuum sealing machine. The handle and locking mechanism of the utility model have the function of saving labor during fastening, and can be operated with a single left or right hand; the handle in the middle can pull lock catches at the two ends to fasten and loosen the cover and the base, so the user can hold the object with a hand; moreover, the cover can open largely to facilitate placement of the plastic bags and the interior cleaning.

To solve the mentioned technical problem, the utility model is realized by the following technical solution:

A mechanism for fastening the cover of a vacuum sealing machine comprises an upper-cover top cap, an upper-cover bottom cap, a base, a handle, a rotating shaft and a locking mechanism, wherein said upper-cover top cap and said upper-cover bottom cap are fixedly connected to form an upper cover; said handle passes through said upper-cover top cap; the lower end of said handle is fixedly connected with the rotating shaft; the two ends of said rotating shaft are respectively fixedly connected with said locking mechanism; and said upper-cover bottom cap is provided with a bracket for supporting said rotating shaft.

Furthermore, said locking mechanism comprises a rotating block; said rotating block is fixedly connected with said rotating shaft; one end of said rotating block away from said rotating shaft is hinged with a connecting block; one end of said connecting block away from said rotating block is hinged with a lock catch; said lock catch is hinged with said upper-cover bottom cap at a position in the middle and close to the edge; said lock catch is driven by said connecting block to rotate; and said base is provided with a catching groove corresponding to said lock catch.

Furthermore, said rotating block is hinged with said connecting block through a pin shaft.

Furthermore, said lock catch is hinged with said upper-cover bottom cap through a pin shaft.

Furthermore, said handle is located in the middle part of said rotating shaft.

Furthermore, said upper-cover top cap is provided with a through-hole corresponding to said handle.

Compared with the prior art, the utility model has the following advantages:

1. The utility model reduces the force required by the handle through the handle and the locking mechanism to fulfill the aim of saving labor.

2. The handle drives the rotating shaft and meanwhile drives lock catches at the two ends through a connecting rod system, so the user can operate locking and loosening with a single hand and deal with the required sealing materials with another hand; moreover, the cover can open largely to facilitate placement of plastic bags.

### BRIEF DESCRIPTION OF THE DRAWINGS

The attached drawings provide further description of the utility model, explain the utility model together with the embodiments of the utility model, and do not limit the utility model. Among the attached drawings:

FIG. 1 is a three-dimensional structural view of the utility model.

FIG. 2 is a top perspective view of the utility model.

FIG. 3 is a top view of the utility model;

FIG. 4 is a sectional view of an A-A lock catch in the loosened state in FIG. 3.

FIG. 5 is a sectional view of an A-A lock catch in the fastened state in FIG. 3.

FIG. 6 is an exploded view of the utility model.

1—Upper-cover top cap; 2—upper-cover bottom cap;

3—base; 4—handle;

5—rotating shaft; 6—through-hole

7—bracket; 8—rotating block;

9—pin shaft; 10—connecting block;

11—lock catch; 12—catching groove.

### DETAILED DESCRIPTION OF THE INVENTION

The preferable embodiment of the utility model is described with reference to the attached drawings. It should be understood that the preferable embodiment provided here is only used for describing and explaining the utility model and shall not limit the utility model.

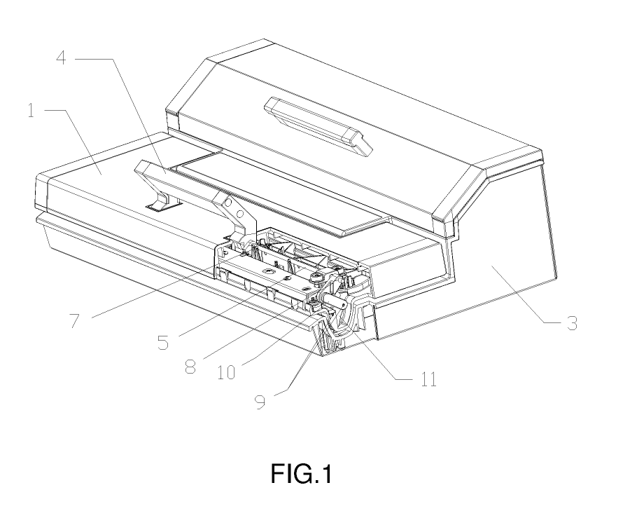

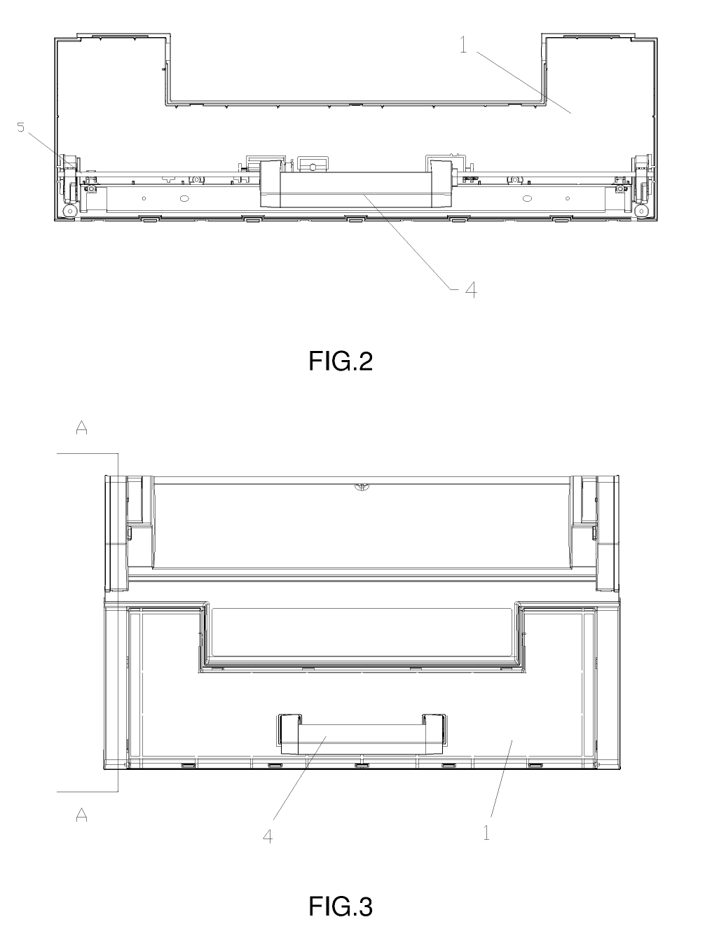

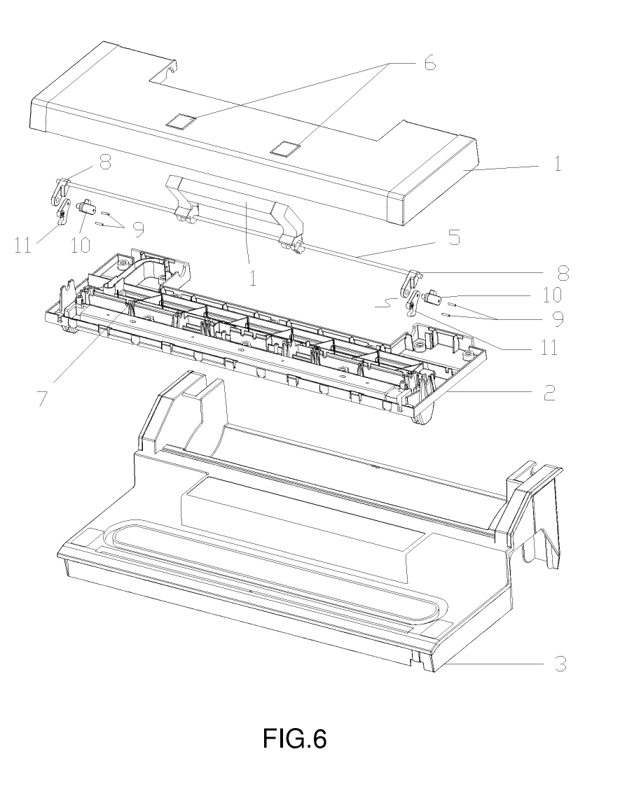

As shown in FIGS. 1-6, the utility model discloses a mechanism for fastening the cover of a vacuum sealing machine, comprising an upper-cover top cap 1, an upper-cover bottom cap 2, a base 3, a handle 4, a rotating shaft 5 and a locking mechanism; wherein the upper-cover top cap 1 and the upper-cover bottom cap 2 are fixedly connected to form an upper cover; the upper-cover top cap 1 is provided with a through-hole 6 corresponding to the handle 4; the handle 4 is located in the middle part of the rotating shaft 5; the handle 4 passes through the upper-cover top cap 1 via the through-hole 6; the lower end of the handle 4 is fixedly connected with the rotating shaft 5; the two ends of the rotating shaft 5 are respectively fixedly connected with the locking mechanism; and the upper-cover bottom cap 2 is provided with a bracket 7 for supporting the rotating shaft 5.

The locking mechanism comprises a rotating block 8; the rotating block 8 is fixedly connected with two ends of the rotating shaft 5; one end of the rotating block 8 away from said rotating shaft 5 is hinged with a connecting block 10 through a pin shaft 9; one end of the connecting block 10 away from the rotating block 8 is hinged with a lock catch 11; the lock catch 11 is hinged with the upper-cover bottom cap 2 at a position in the middle and close to the edge through the pin shaft 9; the lock catch 11 is driven by the connecting block 10 to rotate; and the base 3 is provided with a catching groove 12 corresponding to the lock catch 11.

The working process of the utility model is as follows:

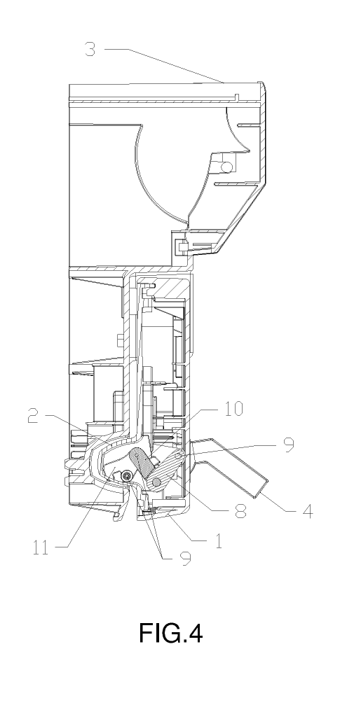

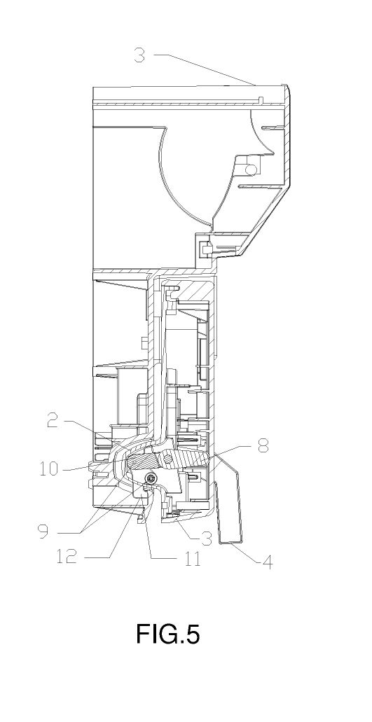

As shown in FIG. 4 to FIG. 5, a user pulls the handle 4 to rotate the rotating shaft 5 and the rotating block 8; the rotating block 8 drives the lock catch 11 to rotate by the connecting block 10; the lock catch 11 rotates and then one end enters the catching groove 12; the lock catch 11 pulls the upper cover to sink to fasten the upper cover and the base 3.

Finally, it should be noted that: the above is only a preferable embodiment of the utility model, and is not used for limiting the utility model. Although the utility model is described in detail with the reference to the embodiment, those skilled in this field can also revise the technical solutions of various embodiments, or perform equivalent substitution for part of the technical features; however, within the spirit and principle of the utility model, any revision, equivalent substitution and improvement all shall be included in the protective scope of the utility model.

What is claimed is:

1. A mechanism for fastening the cover of a vacuum sealing machine, comprising an upper-cover top cap, an upper-cover bottom cap, a base, a handle, a rotating shaft and a locking mechanism; wherein said upper-cover top cap and said upper-cover bottom cap are fixedly connected to form an upper cover; said handle passes through said upper-cover top cap; the lower end of said handle is fixedly connected with the rotating shaft; the two ends of said rotating shaft are respectively fixedly connected with said locking mechanism; and said upper-cover bottom cap is provided with a bracket for supporting said rotating shaft.

2. The mechanism for fastening the cover of a vacuum sealing machine according to claim 1, characterized in that: said locking mechanism comprises a rotating block;
said rotating block is fixedly connected with said rotating shaft; one end of said rotating block away from said rotating shaft is hinged with a connecting block; one end of said connecting block away from said rotating block is hinged with a lock catch; said lock catch is hinged with said upper-cover bottom cap at a position in the middle and close to the edge; said lock catch is driven by said connecting block to rotate; and said base is provided with a catching groove corresponding to said lock catch.

3. The mechanism for fastening the cover of a vacuum sealing machine according to claim 2, characterized in that said rotating block is hinged with said connecting block through a pin shaft.

4. The mechanism for fastening the cover of a vacuum sealing machine according to claim 2, characterized in that said lock catch is hinged with said upper-cover top cap through a pin shaft.

5. The mechanism for fastening the cover of a vacuum sealing machine according to claim 2, characterized in that said handle is located in the middle part of said rotating shaft.

6. The mechanism for fastening the cover of a vacuum sealing machine according to claim 1, characterized in that said upper-cover top cap is provided with a through-hole corresponding to said handle.
